(19) United States
(12) Patent Application Publication
(10) Pub. No.: US 2013/0058735 A1
(43) Pub. Date: Mar. 7, 2013

(54) STRUCTURE OF CONCRETE SCREW

(71) Applicant: PEN-CHANG YU, New Taipei City (TW)

(72) Inventor: PEN-CHANG YU, New Taipei City (TW)

(21) Appl. No.: 13/223,327

(22) Filed: Sep. 1, 2011

(51) Int. Cl. F16B 25/00

(52) U.S. Cl. 411/386

(57) ABSTRACT

A concrete screw includes a rod body which has a top end forming a head for tightening operation and a bottom end forming an engaging section. A first thread is formed on the rod body and extends, at a helix angle between 16 and 23 degrees, from the head toward the engaging section. The first thread has a top-side flank that defines a first thread flank angle ranging from 90 to 120 degrees with respect to the rod body. The first thread has a pitch that ranges from 5 mm to 20 mm. Three cutting notches are formed in and distributed along the first thread and are close to the engaging section. The cutting notches have a depth substantially corresponding to a distance from an apex of the first thread to the rod body. The rod body may selectively form a second thread extending between the head and the engaging section.

### (a) TECHNICAL FIELD OF THE INVENTION

The present invention generally relates to a concrete screw, and more particularly to an improved structure of concrete screw that is easy to manufacture and provides a sound and firm screwing operation.

### (b) DESCRIPTION OF THE PRIOR ART

A conventional concrete screw is often structured to simply form a helical thread on an elongate cylindrical shank. The thread angle of the conventional concrete screw does not show an excellent performance in tightening and un-tightening the concrete screw and does not provide a sound and firm fastening result. Further, the conventional concrete screw, once tightened, cannot be easily unscrewed if desired. Due to the fact that the structure and material of the conventional concrete screw are generally poor and weak, the conventional concrete screw may get easily broken during a tightening operation and this leads to troubles and dangers of the tightening operation. Further, the conventional concrete screw is poor in maintaining a balanced condition and this makes it hard to maintain the conventional screw in a condition of being substantially perpendicular to a work surface in a screwing operation.

In summary, the conventional concrete screw shows the following drawbacks and problems that require further improvements:

(1) The conventional concrete screw is structured in such a way that the thread angle and the material used to make the screw make the conventional concrete screw from being readily screwed and unscrewed.

(2) The conventional concrete screw shows poor positional balance so that it is difficult to maintain the conventional concrete screw substantially perpendicular to a work surface in a screwing operation.

Thus, it is desired for the industry and the screw manufacturers to provide an improved concrete screw that overcomes these problems.

### SUMMARY OF THE INVENTION

In view of the drawbacks and problems discussed above, the present invention aims to provide an improved structure of concrete screw that is easy to manufacture and screw and allows a sound and firm screwing operation.

The primary objective of the present invention is to overcome the problem that the conventional concrete screw is structured in such a way that the thread angle and the material used to make the conventional concrete screw make it difficult for the conventional concrete screw to readily tighten and unscrew, in order to provide a practical advantage of being easy to tighten and manufacture.

To achieve the above objective, the present invention provides an improved structure of concrete screw that comprises a rod body, a first thread, and a plurality of cutting notches. The rod body has a top end that forms a head for tightening operation and a bottom end that forms an engaging section. The first thread is formed around the rod body and the first thread extends, at a helix angle in a range between 16 and 23 degrees, from the head toward the engaging section. The first thread has a top-side flank that defines a first thread flank angle with respect to the rod body in such a way that the thread flank angle ranges from 90 to 120 degrees. This angle is easy to machine and manufacture. The first thread has a pitch that ranges from 5 mm to 20 mm. The cutting notches are distributed along the first thread and are located close to the engaging section. The cutting notches have a depth that is substantially corresponding to the distance between an apex of the first thread to the rod body. This arrangement allows easy tightening and un-screwing.

Another objective of the present invention is to overcome the problem that the conventional concrete screw does not show excellent position balance and cannot easily maintain substantially perpendicular to a work surface in proceeding with a screwing operation, so as to provide a practical advantage of providing a sound and firm screwing operation.

To achieve the objective, the present invention provides a concrete screw that has a rod body on which a second thread is formed between a head and an engaging section of the concrete screw. The second thread is of a height that is generally smaller than the first thread and an included angle between top-side flank and bottom-side flank of the second thread is in a range between 40 and 47 degrees. The second thread provides a function of guidance for screwing operation and makes the screwing operation stable and smooth.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing.

FIG. 2 is a front view showing the concrete screw in accordance with the preferred embodiment of the present invention.

FIG. 3 is a partial enlarged view, in a sectioned form, showing a first thread flank angle of the concrete screw in accordance with the preferred embodiment of the present invention.

FIG. 4 is an enlarged end view showing cutting notches of the concrete screw in accordance with the preferred embodiment of the present invention.

FIG. 5 is a perspective view showing a concrete screw constructed in accordance with another preferred embodiment of the present invention.

FIG. 6 is a partial enlarged view, in a sectioned form, showing the concrete screw in accordance with said another preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

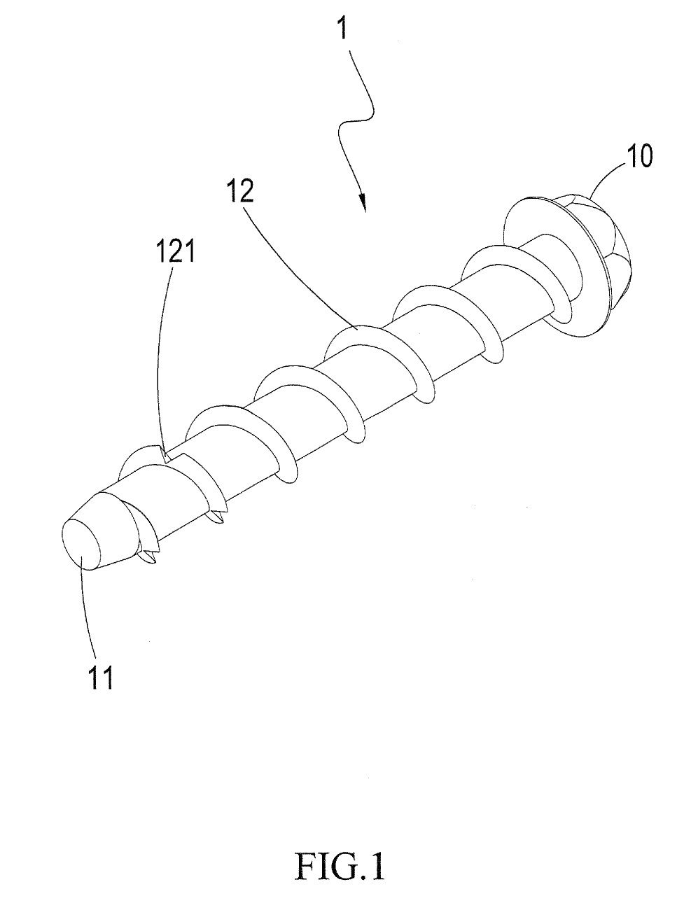

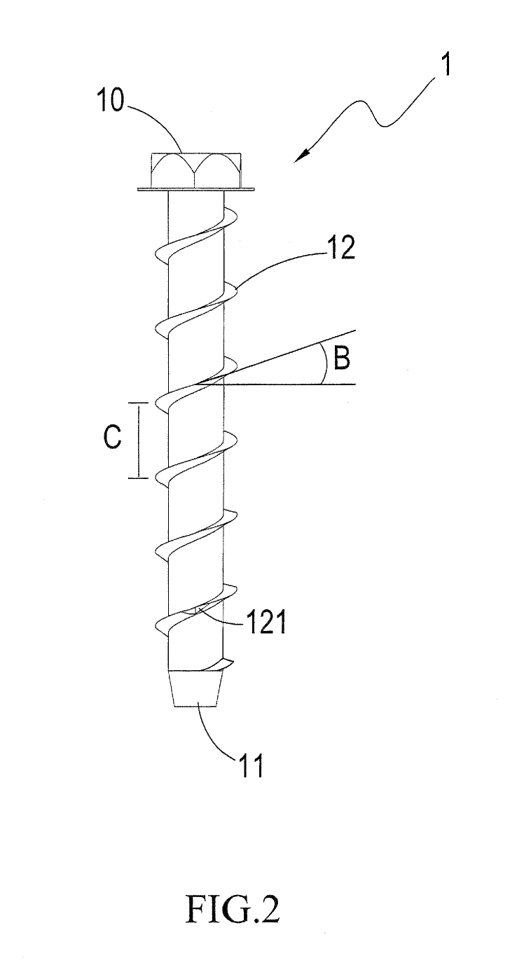

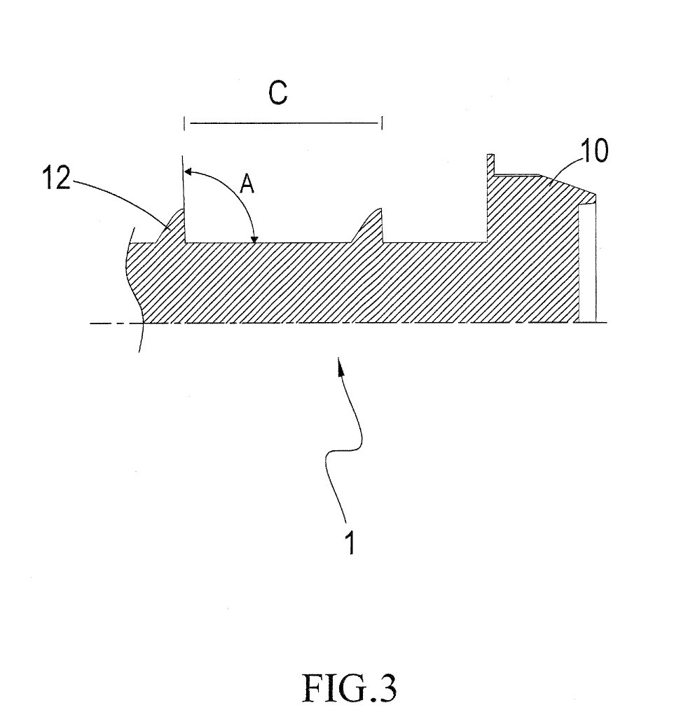

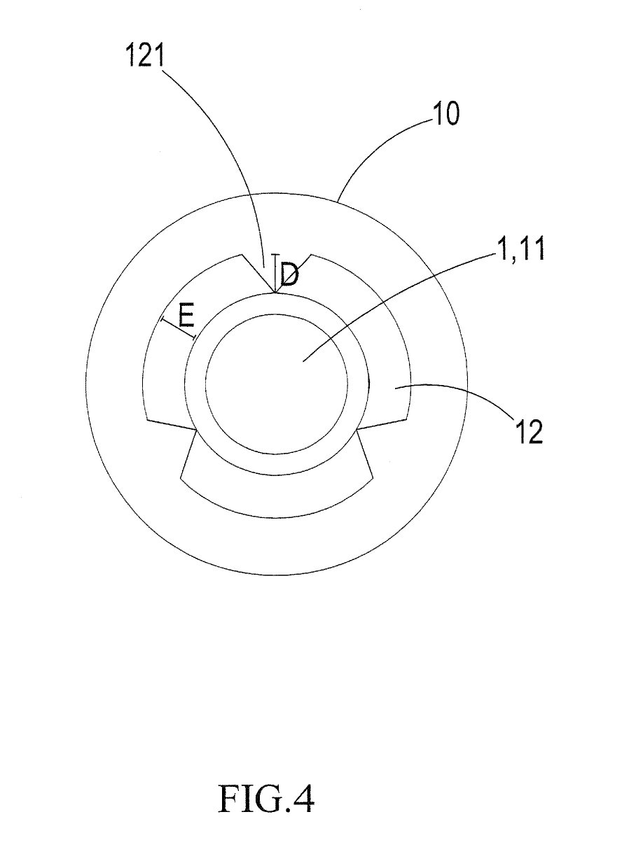

Referring to FIGS. 1, 2, 3, and 4, which are respectively a perspective view and a front view showing a concrete screw constructed in accordance with a preferred embodiment of the present invention, a partial enlarged view, in a sectioned form, showing a first thread flank angle of the concrete screw of the present invention, and an enlarged end view showing cutting notches of the concrete screw of the present invention, these drawings clearly show that the present invention provides an improved structure of concrete screw, which comprises: a rod body 1 that has a top end forming a head 10 for tightening operation and a bottom end forming an engaging section 11; a first thread 12 formed on the rod body 1 and extending at a helix angle B in a range between 16 and 23 degrees from the head 10 toward the engaging section 11, the first thread 12 having a top-side flank that defines a first thread flank angle A with respect to the rod body 1, the first thread flank angle A ranging from 90 to 120 degrees, the first thread having a pitch C that ranges from 5 mm to 20 mm; and a plurality of cutting notches 121 that is formed in and distributed along the first thread 12 and is close to the engaging section 11, the cutting notches having a depth D that is substantially corresponding to a distance E from an apex of the first thread 12 to the rod body 1.

With the above structure and arrangement, the operation of the present invention will be described as follows. The first thread 12 is arranged to extend at a helix angle B in a range between 16 and 23 degrees from the head 10 toward the engaging section 11. The first thread 12 has a top-side flank that defines a first thread flank angle A with respect to the rod body 1 and the first thread flank angle A ranges from 90 to 120 degrees. This arrangement provides two functions, of which one is an advantage of easy tightening and easy un-screwing and providing easy and effortless tightening operation. The first thread 12 forms in a portion thereof close to the engaging section cutting notches 121 that are distributed along the first thread in a direction toward the head 10 and are respectively formed at every 120 degree angular interval. The cutting notches 121 improves cutting sharpness and reduces the frictional effect induced in a tightening operation to allow easy cutting in and tightening. The second function is excellent tightening result and allowing of easier machining than the conventional concrete screws. Thus, operation and technique are both economically efficient. It is noted that the concrete screw of the present invention may be subjected to heat treatment, so that besides having an improved structural strength, the concrete screw is light in weight and is durable in use, making it repeatedly reusable.

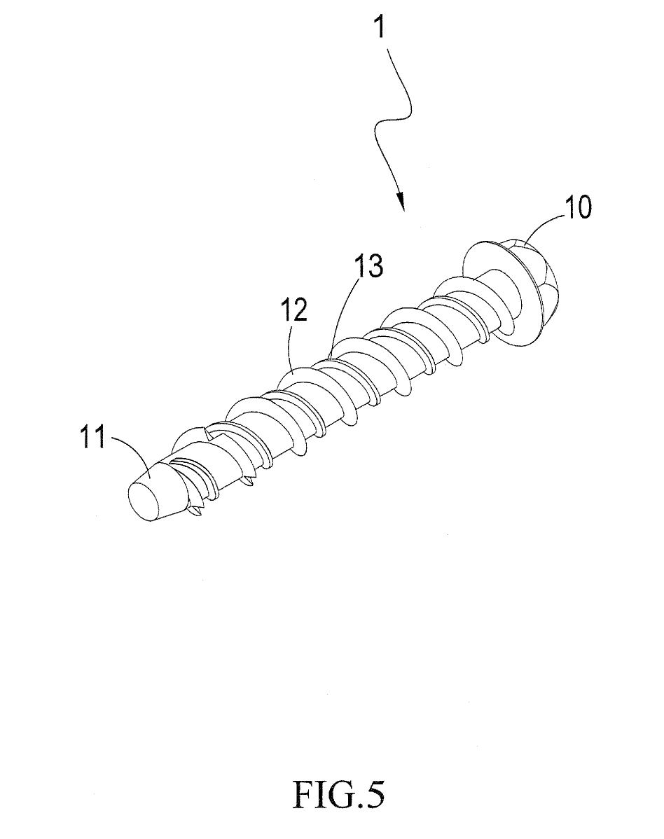

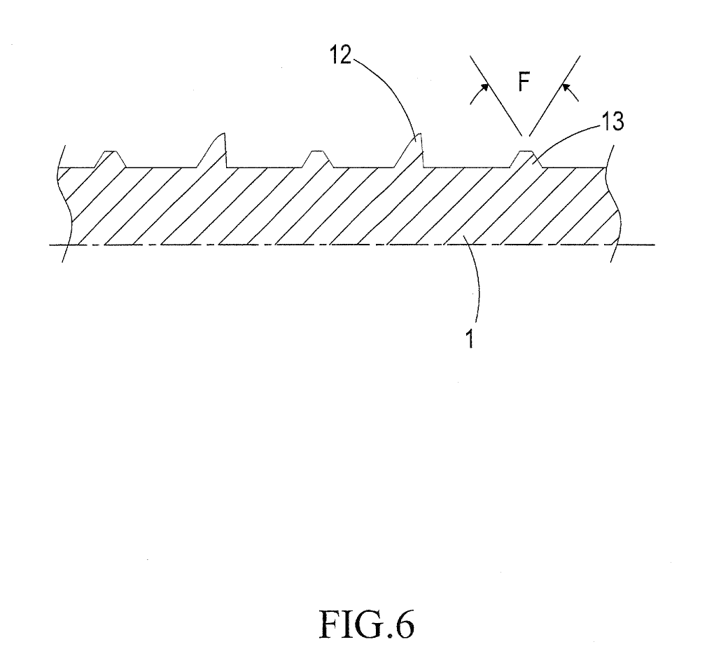

Another embodiment according to the present invention will also be described herein in respect f the structure and operation thereof. Reference is now made to FIGS. 5 and 6, which are respectively a perspective view and a partial enlarged view, in a sectioned form, showing a concrete screw constructed in accordance with said another preferred embodiment of the present invention. These drawings clearly show that the structure of the instant embodiment is substantially identical to that of the previous embodiment, and a difference resides in that in the instant embodiment, the rod body 1 forms a second thread 13 extending between the head 10 and the engaging section 11. The second thread 13 has a height that is smaller than the first thread 12. The second thread 13 has top-side and bottom-side flanks that form therebetween an included angle F ranging from 40 to 47 degrees. The second thread 13 provides a function of guidance for screwing operation and makes the screwing operation stable and smooth.

Referring to all the drawings, it is clear that the present invention, when put into use, provides the following advantages as compared to the conventional screws:

(1) The first thread flank angle A is between 90 and 120 degrees, making it easy to tighten and un-screw and providing an advantage of ready and effortless tightening operation.

(2) The cutting notches 121 improve cutting sharpness and reduce the frictional effect induced in a tightening operation to allow easy cutting in and tightening.

(3) The machining of the concrete screw of the present invention is easier than that of the conventional ones, so that operation and technique are both economically efficient.

(4) The concrete screw of the present invention may be subjected to heat treatment, so that besides having an improved structural strength, the concrete screw is light in weight and is durable in use, making it repeatedly reusable.

(5) The arrangement of the second thread 13 provides guidance for screwing operation and makes the screwing operation stable and smooth

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A concrete screw, comprising:
a rod body, which has a top end forming a head for tightening operation and a bottom end forming an engaging section;
a first thread, which is formed on the rod body and extends from the head toward the engaging section, the first thread having a top-side flank that defines a first thread flank angle with respect to the rod body, the first thread flank angle ranging from 90 to 120 degrees; and
a plurality of cutting notches, which is formed in and distributed along the first thread and is close to the engaging section.

2. The concrete screw according to claim 1, wherein the first thread forms a helix angle that ranges from 16 to 23 degrees.

3. The concrete screw according to claim 1, wherein the first thread has a pitch that ranges from 5 mm to 20 mm.

4. The concrete screw according to claim 1, wherein the cutting notches have a depth that is substantially corresponding to a distance from an apex of the first thread to the rod body.

5. The concrete screw according to claim 1, wherein the rod body forms a second thread extending between the head and the engaging section, the second thread having a height that is smaller than the first thread.

6. The concrete screw according to claim 5, wherein the second thread has top-side and bottom-side flanks that form therebetween an included angle ranging from 40 to 47 degrees.
